(19) United States
(12) Patent Application Publication
(10) Pub. No.: US 2014/0113621 A1
(43) Pub. Date: Apr. 24, 2014

(54) Methods and Nodes in a Communication Infrastructure

(71) Applicant: Huawei Technologies Co., Ltd., Shenzhen (CN)

(72) Inventors: Jacob Lerenius, Kista (SE); Yu Deng, Shenzhen (CN)

(73) Assignee: Huawei Technologies Co., Ltd., Shenzhen (CN)

(21) Appl. No.: 14/143,114

(22) Filed: Dec. 30, 2013

Related U.S. Application Data
(63) Continuation of application No. PCT/EP2012/068557, filed on Sep. 20, 2012.

(51) Int. Cl. H04W 48/16

(52) U.S. Cl. CPC H04W 48/16
USPC 455/426.1

(57) ABSTRACT

Receiver and method for accessing an access point of a wireless local area network. The receiver is configured both for communication with a cellular radio network node comprised in a cellular network, and for accessing the wireless local area network via the access point. The method comprises acquiring a cell ID from a memory of the receiver, which cell ID has been received from said node, matching the acquired cell ID with a cell ID stored in a table, together with at least one reference to an access point associated therewith, detecting the access point, which is associated with the acquired cell ID in the table by searching for the access point, and accessing the wireless local area network via the detected access point.

### CROSS-REFERENCE TO RELATED APPLICATION

This application is a continuation of International Application No. PCT/EP2012/068557, filed on Sep. 20, 2012, which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

Implementations described herein relate generally to a receiver and a method in a receiver. In particular, herein is described a mechanism for accessing an access point of a wireless local area network.

### BACKGROUND

Wireless Fidelity (Wi-Fi), which also may be spelled Wifi, WiFi or WIFI, is a popular technology that allows an electronic device to exchange data wirelessly over a computer network, including high-speed Internet connections. The Wi-Fi Alliance defines Wi-Fi as any “Wireless Local Area Network (WLAN) products that are based on the Institute of Electrical and Electronics Engineers' (IEEE) 802.11 standards.”

A device that is configured to use Wi-Fi may be a personal computer, video game console, smartphone, tablet, or digital audio player. The device in the present context may be, for example, portable, pocket-storable, hand-held, computer-comprised, or vehicle-mounted mobile devices, enabled to communicate voice and/or data, via the radio access network, with another entity, such as another device, a radio network node or a server. The device may connect to a network resource such as the Internet via a wireless network access point. Such an access point, or hotspot as it also may be referred to, may have a range of about 20 meters (65 feet) indoors and a greater range outdoors. Hotspot coverage may comprise an area as small as a single room with walls that block radio waves or as large as many square miles, which may be achieved by using multiple overlapping access points.

In a Wi-Fi enabled device, the device needs to search for networks to be able to connect. Users may manually turn this feature on, or use an automatic scanning algorithm to scan for networks. The present algorithms are based on time, sleep state of the device and/or the position of the device. The position is given by the global positioning system (GPS) or derived from the network. It is based on the operator network or third party services. To constantly search for networks and try to connect to known or open networks consumes power, which is a disadvantage in particular for handheld devices as such devices due to portability demands are restricted to use battery power, and also to use a battery with limited size and capacity.

Further, if a network uses a hypertext transfer protocol (HTTP) based authentication method, the connection may even be blocked while the device is connected. A network based location is given by the operator who uses the base station's information to approximate the position of the device.

To be able to perform tasks using a device location, the actual position (map coordinates) are needed and may be obtained by using a GPS system (GLONASS etc. included), or by getting an approximated location from a service on the outside of the device (internet, network etc.). When performing a task based on a relationship of two parameters, the actual location (map coordinates) is not needed.

Multiple solutions using “location based services” exist today. These solutions use the position (map coordinates) to perform a specific task. By knowing the rough position, the Wi-Fi may be turned on when the user of the device enters a specific area. This is a two step procedure, Wi-Fi location is saved in the device and a location based service is connected to this location plus some kind of radius (margin). When the phone location (map coordinates) matches the saved location, an action is performed.

When the location based service is running, the phone is constantly getting the location (map coordinates) from various sources such as the operator network, the Wi-Fi networks around the device and a GPS system. The idea behind this is to enable various location based services such as alarms, social network check-ins and others. The solution consumes energy as various power hungry functions such as the cellular radio, the Wi-Fi and the GPS are used. Using Wi-Fi to decide when to turn Wi-Fi on and off shows that this solution is not really meant to save power in the device, but rather to improve the user experience. However, such a solution is likely to drain battery power of the device.

Another problem with existing Wi-Fi solutions is that, when the Wi-Fi functionality is activated, the device is configured to search and connect to any open Wi-Fi access point it may discover. However, a hostile eavesdropper may set up its own Wi-Fi access point, scan the traffic passing it and possibly utilise that information for taking advantage of the user by achieving identity related information, bank information, passwords and/or other sensible or secret information.

### SUMMARY

It is therefore an object to obviate at least some of the above mentioned disadvantages and to improve the performance in a communication infrastructure.

According to a first aspect, the object is achieved by a method in a receiver, for accessing an access point of a wireless local area network. The receiver is configured both for radio communication with a cellular radio network node comprised in a cellular network, and for accessing the wireless local area network via the access point. The method comprises acquiring a cell identifier (ID) from a memory of the receiver, which cell ID has been received from the cellular radio network node. Further, the method also comprises matching the acquired cell ID with a cell ID stored in a table, comprising at least one stored cell ID and at least one reference to an access point associated therewith. Also, the method in addition comprises detecting the access point of the wireless local area network, which is associated with the acquired cell ID in the table by searching for the access point. The method also further comprises accessing the wireless local area network via the detected access point.

According to a second aspect, the object is achieved by a receiver, for accessing an access point of a wireless local area network. The receiver is configured both for radio communication with a cellular radio network node comprised in a cellular network, and for accessing the wireless local area network via the access point. The receiver comprises a receiving unit configured for receiving a cell ID from the cellular radio network node. Furthermore, the receiver comprises a processing circuit. The processing circuit is configured for acquiring a cell ID from a memory of the receiver, which cell ID has been received from the cellular radio network node. Further, the processing circuit is also configured for matching the acquired cell ID with a stored cell ID in a table comprising at least one stored cell ID and at least one reference to an access point associated therewith. Further, the processing circuit is also in further addition configured for detecting the access point of the wireless local area network, which is associated with the acquired cell ID in the table, by searching for the access point. Also, the processing circuit is further configured for accessing the wireless local area network via the access point. The receiver also comprises a memory. The memory is configured for storing the cell ID received from the cellular radio network node. Further, the memory is also configured for storing the at least one cell ID and the at least one reference to the access point associated therewith in the table.

Some advantages according to embodiments herein comprise that network performance is enhanced while energy is saved and battery operational life time between reload is extended. A further advantage of some embodiments is that security is enhanced, as access to a hostile access point of a wireless local area network is avoided.

This is achieved by avoiding making an access point scanning, or making such scanning at a less frequent interval, in areas where it may be expected that the user is not interested in accessing the wireless local area network anyway.

Further, by letting information already available in the receiver, the cell ID, determine when to activate the scanning for the wireless local area network, instead of a geographical location, further energy is saved, as no request or GPS measurement for geographical location has to be made. Thus, an improved performance within a wireless communication infrastructure is provided.

Other objects, advantages and novel features of the described embodiments of the invention will become apparent from the following detailed description.

### BRIEF DESCRIPTION OF THE DRAWINGS

Embodiments of the invention are described in more detail with reference to attached drawings illustrating examples of embodiments in which:

FIG. 1 is a block diagram illustrating an embodiment of the invention.

FIG. 2 is a block diagram illustrating a table according to an embodiment of the invention.

FIG. 3A is a block diagram illustrating an infrastructure overview wherein the invention is implemented.

FIG. 3B is a block diagram illustrating an infrastructure overview wherein the invention is implemented.

FIG. 4 is a flow chart illustrating a method according to some embodiments, for collecting data to be entered in the table.

FIG. 5 is a flow chart illustrating a method according to some embodiments, for utilising data collected in the table for detecting an access point.

FIG. 6 is a flow chart illustrating a method in a receiver according to an embodiment of the invention.

FIG. 7 is a block diagram illustrating a receiver according to an embodiment of the invention.

### DETAILED DESCRIPTION

Embodiments of the invention described herein are defined as a receiver and a method in a receiver, which may be put into practice in the embodiments described below. These embodiments may, however, be exemplified and realised in many different forms and are not to be considered as limited to the embodiments set forth herein; rather, these embodiments are provided so that this disclosure will be thorough and complete.

Still other objects and features may become apparent from the following detailed description considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

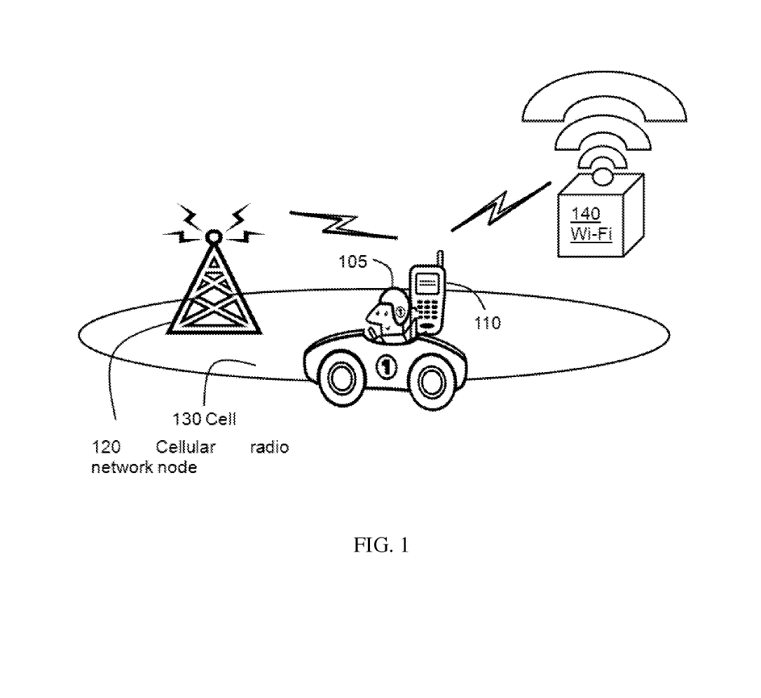

FIG. 1 is a schematic illustration over a wireless communication infrastructure. The wireless communication infrastructure may at least partly comprise a cellular radio network, which in turn may be based on radio access technologies such as e.g. Third Generation Partnership Project (3GPP) Long Term Evolution (LTE), LTE-Advanced, Evolved Universal Terrestrial Radio Access Network (E-UTRAN), Universal Mobile Telecommunications System (UMTS), Global System for Mobile Communications (originally: Groupe Special Mobile) (GSM)/Enhanced Data rate for GSM Evolution (GSM/EDGE), Wideband Code Division Multiple Access (WCDMA), Worldwide Interoperability for Microwave Access (WiMax), Ultra Mobile Broadband (UMB), High Speed Packet Access (HSPA) Evolved Universal Terrestrial Radio Access (E-UTRA), Universal Terrestrial Radio Access (UTRA), GSM EDGE Radio Access Network (GERAN), 3GPP2 CDMA technologies e.g. CDMA2000 1× RTT and High Rate Packet Data (HRPD), just to mention some few options.

The cellular radio network may be configured to operate according to the Time Division Duplex (TDD) and/or the Frequency Division Duplex (FDD) principle, according to different embodiments. TDD is an application of time-division multiplexing to separate uplink and downlink signals in time, possibly with a Guard Period situated in the time domain between the uplink and downlink signalling. FDD means that the transmitter and receiver operate at different carrier frequencies, as have previously been discussed.

The purpose of the illustration in FIG. 1 is to provide a simplified, general overview of the methods and nodes, such as cellular radio network node and receiver herein described, and the functionalities involved. The method and receiver will subsequently, as a non-limiting example, be described in a 3GPP/LTE environment, but the embodiments of the disclosed methods, radio network node and receiver may operate in a wireless communication system based on another access technology such as e.g. any of the above enumerated. Thus, although the embodiments of the invention are described based on, and using the lingo of, 3GPP LTE systems, it is by no means limited to 3GPP LTE.

The illustration in FIG. 1 comprises a human user 105 of a receiver 110 and a cellular radio network node 120, which is serving a cell 130. Further, an access point 140 of a wireless local area network is illustrated. The wireless local area network, or WLAN, may be Wi-Fi as defined by any of IEEE standards 802.11a, b, g and/or n. The Wi-Fi network is configured to exchange data wirelessly, using radio waves over a computer network, including high-speed Internet connections. It is to be noted that the expressions wireless local area network and/or Wi-Fi may be used somewhat interchangeably with each other within the current context.

The receiver 110 is configured for communication both over the cellular radio communication network via the cellular radio network node 120, and over the wireless local area network via the access point 140. Further, the receiver 110 may comprise, or be represented by, a User Equipment (UE), a wireless communication terminal, a mobile cellular phone, a Personal Digital Assistant (PDA), a wireless platform, a mobile station, a portable communication device, a laptop, a computer, a wireless terminal acting as a relay, a relay node, a mobile relay, a Customer Premises Equipment (CPE), a Fixed Wireless Access (FWA) node, a personal computer, a video game console, a smartphone, a tablet, a digital audio player or any other kind of device configured to communicate wirelessly with the cellular radio network node 120 and the access point 140, according to different embodiments and different vocabulary.

The receiver 110 is configured to transmit radio signals comprising information to be received by the cellular radio network node 120. Correspondingly, the receiver 110 is configured to receive radio signals comprising information transmitted by the cellular radio network node 120.

It is to be noted that the illustrated network setting of one receiver 110 and one cellular radio network node 120 in FIG. 1 is to be regarded as a non-limiting example of an embodiment only. The wireless communication system may comprise any other number and/or combination of cellular radio network nodes 120 and/or receivers 110, although only one instance of a receiver 110 and a cellular radio network node 120, respectively, are illustrated in FIG. 1, for clarity reasons. A plurality of receivers 110 and cellular radio network nodes 120 may further be involved in some embodiments of the disclosed invention.

Thus, whenever “one” or “a/an” receiver 110 and/or cellular radio network node 120 is referred to in the present context, a plurality of receivers 110 and/or cellular radio network nodes 120 may be involved, according to some embodiments.

The cellular radio network node 120 controls the radio resource management within the cell 130, such as e.g. allocating radio resources to the receiver 110 within the cell 130 and ensuring reliable wireless communication between the cellular radio network node 120 and the receiver 110. The cellular radio network node 120 may typically comprise an evolved Node B (eNodeB), e.g. in an LTE-related wireless communication system.

The cellular radio network node 120 may according to some embodiments be referred to as e.g. base stations, NodeBs, evolved Node Bs (eNBs, or eNode Bs), base transceiver stations, Access Point Base Stations, base station routers, Radio Base Stations (RBSs), macro base stations, micro base stations, pico base stations, femto base stations, Home eNodeBs, sensors, beacon devices, relay node repeaters or any other network nodes configured for communication with the receiver 110 over a wireless interface, depending e.g. on the radio access technology and terminology used.

The access point 140 of the wireless local area network, which further may be referred to as a hotspot, may have a range of about 20 meters (65 feet) indoors and a somewhat greater range outdoors according to some embodiments. However, the access point 140 may be based on IEEE standard 802.11b or 802.11g with a stock antenna and may have a range of 32 meters (m) (120 feet (ft)) indoors and 95 m (300 ft) outdoors. According to some further embodiments, the access point 140 may be based on IEEE standard IEEE 802.11n, however, and may more than double the enumerated ranges.

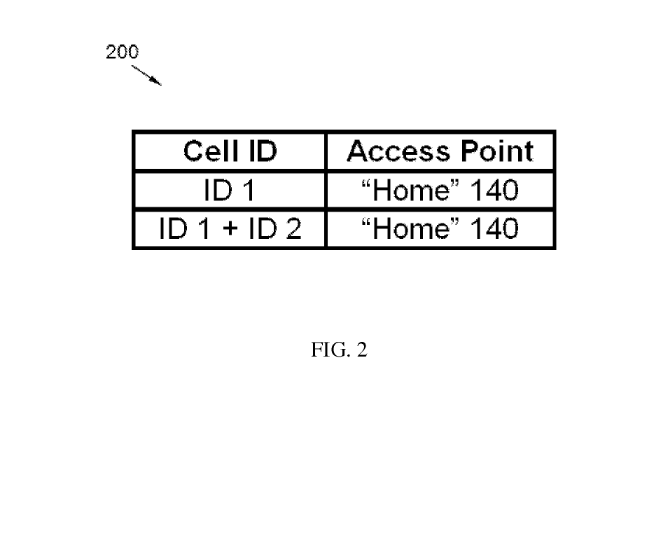

According to some embodiments of the invention, the receiver 110 is configured for accessing the wireless local area network based on parameters already present in the receiver 110, such as cell ID information. Further, a mapping between these and a connected Wi-Fi network may be done to create a table of mapped information. An example of such table is illustrated in FIG. 2.

The table 200 comprises at least one cell ID associated with a reference to an access point 140 of a wireless local area network such as Wi-Fi.

This mapped information comprising the relationship between the cell ID and the associated access point 140 may be used to determine when to turn on and off the Wi-Fi functionality of the receiver 110. By using this method, power may be saved in the receiver 110, because no Wi-Fi scanning has to be made when the receiver 110 is not situated within the cell 130 having that cell ID associated with the Wi-Fi access point 140.

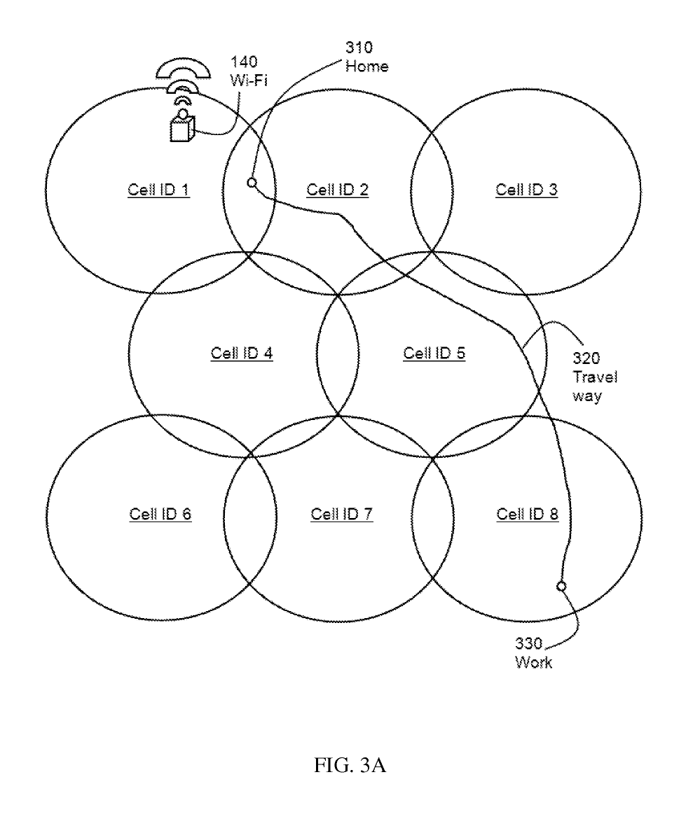

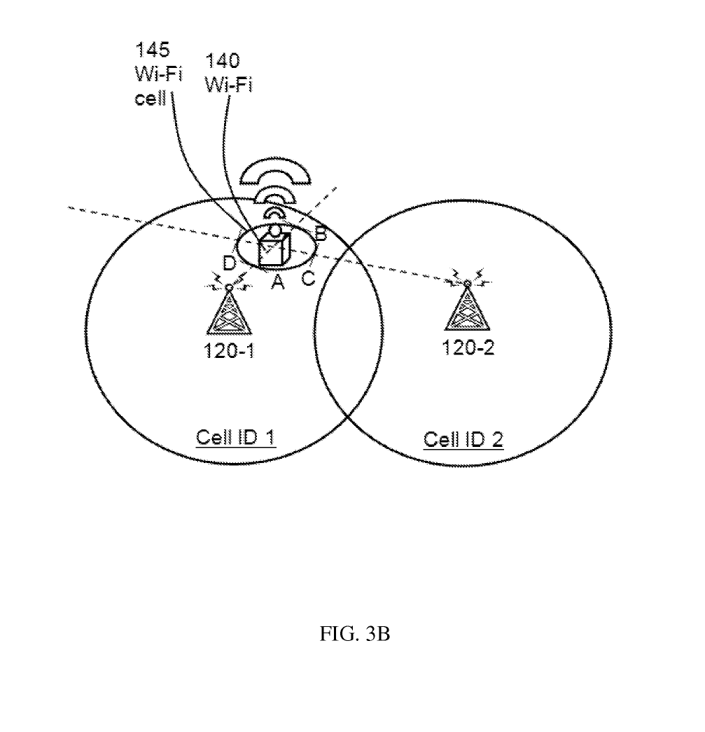

According to some alternative embodiments, the table 200 further may comprise a signal measurement value related to the signal propagation conditions of a signal transmitted from the cellular radio network node 120, indicating an approximation of the signal strength value of a signal as received at the border of the access point range. Such signal measurement value may comprise, or refer to Reference Signal Received Power (RSRP), Reference Signal Received Quality (RSRQ), Received Signal Strength Indicator (RSSI) or any other appropriate measurement related to the signal propagation conditions in the radio interface between the receiver 110 and the cellular radio network node 120. This will be further discussed in conjunction with presentation of FIG. 3B.

Embodiments herein comprise a solution where the current cell ID, or cell IDs, which is/are known by the receiver 110 and stored in a memory of the receiver 110, and create the table 200 with known combinations of the data while connected to the access point 140. Thereby, the receiver 110 may stop searching for any access point 140 to the wireless local area network, or search for such access point 140 less often in areas not matching the cell ID data associated with Wi-Fi access point 140 stored in the table 200 comprised in the receiver 110.

Furthermore, when the human user 105 wants to add a new wireless local area network when the invention is activated, a manual scan may be performed. Another option according to some alternative embodiments may be to still scan for available wireless local area networks but at a much slower rate. The user 105 may in such case have to wait to be notified about the available network. When the user 105 actively selects to utilise a screening for the wireless local area network, i.e. a Wi-Fi search screen, the scanning intensity may be increased.

Some advantages thereby is that the Wi-Fi scanning functionality, which is rather energy intensive, may be activated merely when the user 105 wishes to use the wireless local area network, i.e. for example at his/her home and/or at his/her work etc. Thereby, energy is saved. Further, and as a consequence, the battery charge time of the receiver 110 may be extended. In addition, the risk may be lower of attaching the receiver 110 to a hostile access point 140 which has been established by a criminal in order to scan the traffic/communication for e.g. economical and/or sensitive information. Furthermore, by not having to make any geographical positioning, by e.g. requesting a geographical position from a position server, or a cellular radio network node 120, or by activating GPS functionality, energy is saved. A further advantage of embodiments herein is that the receiver 110 may access the wireless local area network when the receiver 110 is within range of the access point 140, without any particular further action of the user 105. Thereby, the user 105 will experience enhanced throughput, as the traffic to/from the receiver 110 will be transmitted over the wireless local area network via the access point 140 instead of over the cellular radio network. Furthermore, by doing so, the capacity of the cellular radio network, as the resources that otherwise would be used by the receiver 110 may be used by another user.

FIG. 3A illustrates a scenario wherein the user 105, and his/her receiver 110 is travelling from his/her home 310, via a travel way 320 to his/her work 330. The travel way 320 is passing through a plurality of cells 130. However, in the illustrated non-limiting example, the user 105 is only interested in accessing the wireless local area network at the access point 140 in his/her own home 310.

Thus, the user 105 may only have added its home wireless local area network to the table 200, as illustrated in FIG. 2 in some embodiments. The table 200 thus comprises a list of cell ID 1 and cell ID 1+cell ID 2. When the user 105 is initiating his/her travel to the work 330 via the travel way 320, or rather when leaving the cell 130 having the cell ID 1, the wireless local area network functionality of the receiver 110 and the scanning for wireless local area networks is disabled. In an alternative embodiment, the scanning interval for wireless local area networks may be extended. Thus, during the rest of the day, when travelling through the other cells and when at work 330, which is situated in cell ID 8 in FIG. 3A, the wireless local area network functionality will be off or scanning at a lower frequency. This will save large amounts of power of the receiver 110.

The difference from using a positioning service to determine if the receiver 110 is in the same location as an approved access point 140 is that the present methods do not care about the location, only the mapping between cell ID and the Wi-Fi access point Service Set Identification (SSID). As the table 200 may be present always in the modem part of the receiver 110, it will consume a negligible amount of power to process this table 200 before attempting a scan.

A criterion using cell ID data from the cellular network to create the table 200 (the illustrated data structure is a non limiting example only) is used by the receiver 110 before performing a Wi-Fi scan.

According to some embodiments, the table 200 may be established during one single Wi-Fi accession attempt, or during several days or connection attempts to build the table 200 that maps cell ID combinations with Wi-Fi access point 140 before using this table 200 as a rule for Wi-Fi scanning. This may be referred to as a learning period, according to some embodiments.

During such learning period, Wi-Fi scanning may take place, but the period of attempts may be decreased over time.

The scanning may stop when the criterion according to the table 200 is not met, or the period between scan attempts may be increased.

FIG. 3B illustrates a scenario comprising an embodiment wherein a signal measurement value related to the signal propagation conditions of a signal transmitted from the cellular radio network node 120-1 and the cellular radio network node 120-2 respectively. Such signal measurement value may comprise, or refer to RSRP, RSRQ, RSSI or any other appropriate measurement related to the signal propagation conditions in the radio interface between the receiver 110 and the respective cellular radio network nodes 120-1, 120-2.

The access point 140 defines a wireless local area network cell 145, which may be considerably smaller than a cell 130 of the cellular radio network.

According to some embodiments, the table 200 stores signal strength values of signals transmitted from the cellular radio network node 120-1, which defines the cell 130, having the cell ID 1 and the cellular radio network node 120-2, which defines the cell 130, having the cell ID 2.

Thus, the signal strength values of the signals are measured at the border, or thereabout, of the Wi-Fi cell 145. In this non-limiting example, the signal strength values of a signal transmitted from the cellular radio network node 120-1 as received at point A and point B at the border of the Wi-Fi cell 145 are entered into the table 200. Further, the signal strength values of a signal transmitted from the cellular radio network node 120-2 as received at point C and point D at the border of the Wi-Fi cell 145 are entered into the table 200.

The receiver 110 which enters the cell 130 with the cell ID 1 may later measure the signal strength of the signal received from the cellular radio network node 120-1. If that measured signal strength value is in between the measurement values of the table 200 of point A and point B, and the measured signal strength value of the signal received from the other cellular radio network node 120-2 is in between the measurement values of the table 200 of point C and point D, the wireless local area network scanning may be activated.

Thereby, the activation period and/or time for the wireless local area network scanning may be further reduced.

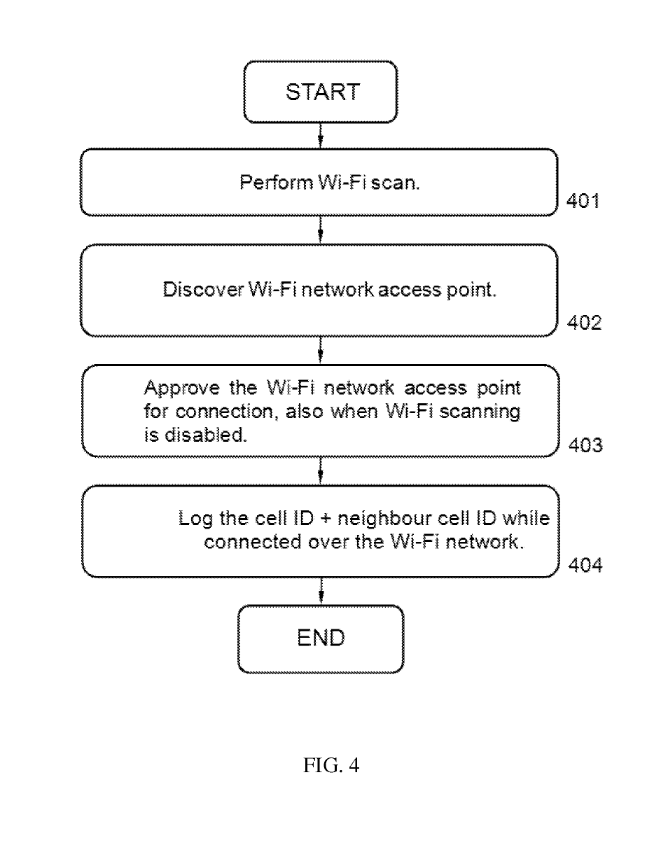

FIG. 4 illustrates an example of an embodiment comprising a learning period, during which the table 200 is established, or completed with data.

When the user 105 desires to add a new wireless local area network access point 140, a manual scan may be performed in a first action 401 by the user 105.

Another option may be to still scan for available wireless local area networks but at a much slower rate, according to some embodiments. The user 105 may in such case have to wait to be notified about the available wireless local area network. If the user 105 actively uses the Wi-Fi search screen, the scan may be higher, according to some embodiments.

Further, during the scan, the wireless local area network access point 140 may be discovered in an action 402.

Thereafter, according to some optional embodiments, the user 105 may approve the wireless local area network access point 140 for connection, also when wireless local area network scanning is disabled, in an action 403.

Additionally, the learning period may comprise the action of logging the cell ID+neighbour cell ID while connected over the wireless local area network, in an action 404.

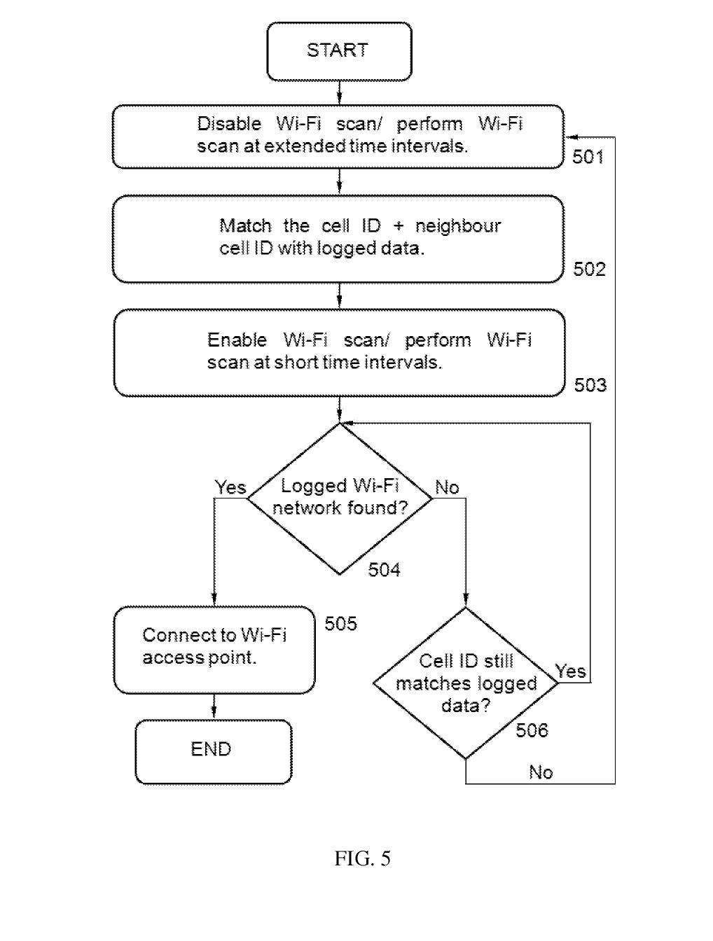

FIG. 5 illustrates an example of an embodiment comprising an implementing period, during which the table 200 is utilised for activating/disabling the wireless local area network functionality of the receiver 110.

In a first action 501, the receiver 110 may disable the wireless local area network functionality. Alternatively, in some embodiments, the receiver 110 may perform wireless local area network scanning at extended time intervals.

Further, the cell ID, which may be comprised in the memory of the receiver 110 may be parsed and matched with the stored data values in the table 200, in an action 502.

In another subsequent action 503, the wireless local area network functionality is enabled. Alternatively, the wireless local area network is scanned at shorter time intervals in case the receiver 110, in a previous action 501 has performed wireless local area network scanning at extended time intervals.

During the wireless local area network scanning a search is thus made for the wireless local area network access point 140 in an action 504. When the logged wireless local area network access point 140 is found, a connection to the wireless local area network access point 140 may be made in an action 505. However, in case the wireless local area network access point 140 is found during the scanning, for example within a certain time period, a check may be made whether the cell ID still matches the logged data in the table 200, in an action 506. If it still matches, the wireless local area network scanning according to action 504 is continued. However, in case no match is made, the wireless local area network scanning may be disabled according to action 501. Alternatively, according to some embodiments, the wireless local area network scanning may be performed at an extended time interval.

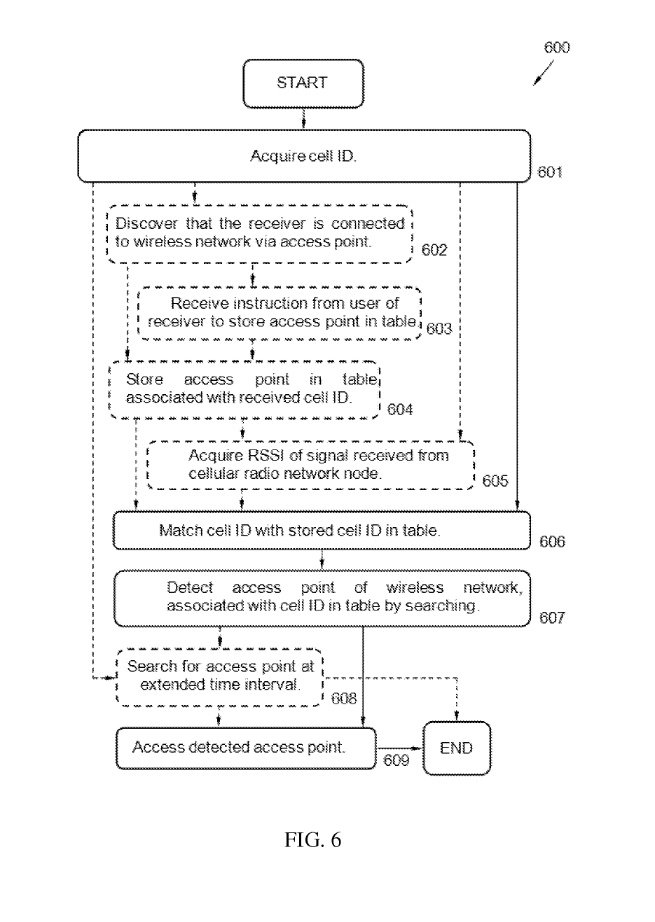

FIG. 6 is a flow chart illustrating embodiments of a method 600 for use in a receiver 110. The method 600 aims at accessing an access point 140 of a wireless local area network. That wireless local area network may comprise a Wi-Fi network as defined by any of IEEE standards 802.11a, b, g and/or n. The receiver 110 is configured both for radio communication with a cellular radio network node 120 comprised in a cellular network, and for accessing the wireless local area network via the access point 140. The cellular network may be based on any radio access technology of: GSM, EDGE, UMTS, Code Division Access (CDMA), CDMA 2000, Time Division Synchronous CDMA (TD-SCDMA), LTE within the 3GPP, or possibly a similar radio access technology, in different embodiments. Furthermore, the cellular radio network node 120 may comprise e.g. an Evolved Node B, while the receiver 110 may comprise a UE.

To appropriately access the access point 140 of the wireless local area network, the method 600 may comprise a number of actions 601-609.

It is however to be noted that any, some or all of the described actions 601-609, may be performed in a somewhat different chronological order than the enumeration indicates, or even be performed simultaneously. Further, it is to be noted that some of the actions, such as e.g. 602, 603, 604, 605 and/or 608 may be performed in some alternative embodiments. The method 600 may comprise the following actions:

Action 601

A cell ID is acquired from a memory 725 of the receiver 110, which cell ID has been received from the cellular radio network node 120. The cellular radio network node 120 may be serving the cell 130 and/or serving the receiver 110. However, the cell ID may be acquired from any cellular radio network node 120.

Action 602

This action may be performed within some alternative embodiments.

It may be discovered, according to some embodiments, that the receiver 110 is connected to the wireless local area network via the access point 140.

According to some further embodiments, the reference to the discovered access point 140 may be stored in the table 200, associated with the acquired 601 cell ID while the receiver 110 may be connected to the wireless local area network via the access point 140.

Action 603

This action may be performed within some alternative embodiments, in which it has been discovered 602 that the receiver 110 is connected to the wireless local area network via the access point 140.

An instruction may be received from a human user 105 of the receiver 110 to store 604 the reference to the discovered 602 access point 140 in the table 200.

Action 604

This action may be performed within some alternative embodiments, in which it has been discovered 602 that the receiver 110 is connected to the wireless local area network via the access point 140.

A reference to the discovered 602 access point 140 in the table 200 may be stored, associated with the acquired 601 cell ID.

Action 605

This action may be performed within some alternative embodiments, wherein the table 200 further comprises a value related to a received signal strength indication of a signal received from the cellular radio network node 120 associated with the reference to the access point 140, and wherein the method 600 further comprises the following action.

The received signal strength indication of a signal received from the cellular radio network node 120 is acquired, such as measured or collected (caught) from the memory of the receiver 110, according to different embodiments.

Action 606

The acquired 601 cell ID is matched with a cell ID stored in a table 200, comprising at least one stored cell ID and at least one reference to an access point 140 associated therewith.

According to some alternative embodiments, the action of matching further may comprise matching the acquired 605 received signal strength indication with the stored received signal strength indication in the table 200.

Action 607

The access point 140 of the wireless local area network, which is associated with the acquired 601 cell ID in the table 200 is detected, by a search for the access point 140.

Action 608

This action may be performed within some alternative embodiments, in case no match 606 is made between the acquired 601 cell ID and any stored cell ID in the table 200, and/or no detection 607 of the access point 140 has been made.

The time interval for searching any access point 140 of the wireless local area network may be extended. The receiver 110 may thus continue searching for available access points, but at extended time intervals. Thus the scanning interval may be extended in this action by for example one second, five seconds, two minutes, thirty minutes, two hours, or any other time interval. The time interval is extendable into infinity. Thus the time interval may be extended into infinity, which means that no further search for the access point 140 at all may be performed, according to some embodiments.

Action 609

The wireless local area network is accessed via the detected 607 access point 140.

When the access to the wireless local area network has been established, the network traffic of the receiver 110 may be communicated via the wireless local area network instead of over the cellular radio network. Thereby, it is possible to communicate more effectively, as the wireless local area network may have a higher capacity than the cellular radio network. In addition, the access to the approved access point 140 may be made without any further action from the human user 105. Furthermore, as the receiver 110 swaps to communication over the wireless local area network, capacity of the cellular radio network may be released and may be used for other users of the cellular radio network.

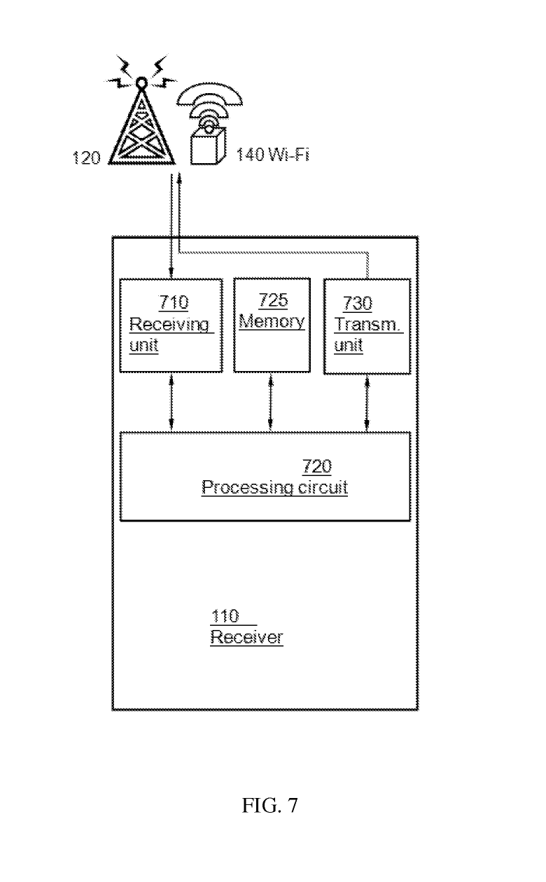

FIG. 7 is a block diagram illustrating a receiver 110 configured both for radio communication with a cellular radio network and also with a wireless local area network. The receiver 110 may access the wireless local area network via the access point 140. Further, the receiver 110 may access the cellular radio network via a cellular radio network node 120.

The wireless local area network may comprise a Wi-Fi network, as defined by any of IEEE standards 802.11a, b, g and/or n. The cellular network may be based on any radio access technology of: GSM, EDGE, UMTS, CDMA, CDMA 2000, TD-SCDMA, LTE within the 3GPP, or possibly a similar radio access technology, in different embodiments. Furthermore, the cellular radio network node 120 may comprise e.g. an Evolved Node B, while the receiver 110 may comprise a UE.

The receiver 110 is configured to perform the different embodiments of the above described method 600 according to any, some or all of the actions 601-609 for accessing the access point 140 of the wireless local area network.

For enhanced clarity, any internal electronics or other components of the receiver 110, not completely indispensable for understanding the herein described embodiments has been omitted from FIG. 7.

The receiver 110 comprises a processing circuit 720 and a memory 725. The processing circuit 720 is configured for acquiring a cell ID from a memory 725 of the receiver 110. The cell ID has been received from the cellular radio network node 120, and also configured for matching the acquired cell ID with a stored cell ID in a table 200, comprising at least one stored cell ID and at least one reference to an access point 140 associated therewith. The table 200 may be stored within the receiver 110, e.g. in the memory 725 of the receiver 110. The processing circuit 720 is additionally configured for detecting the access point 140 of the wireless local area network, which is associated with the acquired cell ID in the table 200, by searching for the access point 140, and further configured for accessing the wireless local area network via the access point 140.

Furthermore, the processing circuit 720 may further be configured, according to some embodiments, for searching for any access point 140 of the wireless local area network, at an extended time interval, in case no match is made between the received cell ID and any stored cell ID in the table 200 and/or, alternatively, no detection of the access point 140 is made.

Additionally, according to some embodiments, the processing circuit 720 may be further configured for measuring the received signal strength indication of a signal received from the cellular radio network node 120. In further addition, the processing circuit 720 may be configured for matching the measured received signal strength indication with the stored received signal strength indication in the table 200.

Furthermore, the processing circuit 720 may be additionally configured for discovering that the receiver 110 is connected to the wireless local area network via the access point 140. The processing circuit 720 may also be configured for storing a reference to the discovered access point 140 in the table 200, associated with the acquired cell ID, in the memory 725.

The processing circuit 720 may further in addition be configured for receiving an instruction from a human user 105 of the receiver 110 to store the reference to the discovered access point 140 in the table 200, before storage in the memory 725.

Also, the processing circuit 720 may furthermore be configured for storing the reference to the discovered access point 140 in the table 200 in the memory 725, associated with the acquired cell ID while the receiver 110 is connected to the wireless local area network via the access point 140, in some embodiments.

The memory 725 is configured for storing the cell ID received from the cellular radio network node 120. The memory 725 is also configured for storing the at least one cell ID and the at least one reference to the access point 140 associated therewith in the table 200.

The table 200 may further, in some embodiments, comprise a value related to a received signal strength indication of a signal received from the cellular radio network node 120 associated with the reference to the access point 140.

The processing circuit 720 may comprise e.g. one or more instances of a Central Processing Unit (CPU), a processing unit, a processing circuit, a processor, an Application Specific Integrated Circuit (ASIC), a microprocessor, or other processing logic that may interpret and execute instructions. The herein utilised expression “processing circuit” may thus represent a processing circuitry comprising a plurality of processing circuits, such as e.g. any, some or all of the ones enumerated above.

The processing circuit 720 may further perform data processing functions for inputting, outputting, and processing of data comprising data buffering and device control functions, such as call processing control, user interface control, or the like.

Further, the receiver 110 comprises a transmitting unit 730 configured for transmitting the information entity on the at least one antenna port associated with the assigned demodulation reference signal (DM-RS) pattern.

In addition, according to some embodiments, the receiver 110 may comprise a receiving unit 710 configured for receiving radio signals over a wireless interface. The radio signals may be received from e.g. the cellular radio network node 120, or any other entity configured for wireless communication according to some embodiments.

The memory 725 may comprise a physical device utilised to store data or programs i.e. sequences of instructions, on a temporary or permanent basis. According to some embodiments, the memory 725 may comprise integrated circuits comprising silicon-based transistors. Further, the memory 725 may be volatile or non-volatile.

The actions 601-609 to be performed in the receiver 110 may be implemented through the one or more processing circuits 720 in the receiver 110, together with computer program code for performing the functions of the actions 601-609. Thus, a computer program product, comprising instructions for performing the actions 601-609 in the receiver 110 may be configured for accessing an access point 140 of a wireless local area network, which receiver 110 is configured both for radio communication with a cellular radio network node 120 comprised in a cellular network, and for accessing the access point 140 of the wireless local area network according to the described method 600 according to the actions 601-609, when the computer program is loaded in a processing circuit 720 of the receiver 110.

The computer program product mentioned above may be provided for instance in the form of a data carrier carrying computer program code for performing at least some of the actions 601-609 according to some embodiments when being loaded into the processing circuit 720. The data carrier may be e.g. a hard disk, a computer disc read-only memory (CD ROM) disc, a memory stick, an optical storage device, a magnetic storage device or any other appropriate medium such as a disk or tape that may hold machine readable data in a non transitory manner. The computer program product may furthermore be provided as computer program code on a server and downloaded to the receiver 110 remotely, e.g. over an Internet or an intranet connection.

The terminology used in the detailed description of the invention as illustrated in the accompanying drawings is not intended to be limiting of the described method 600 and receiver 110, which instead are limited by the enclosed claims.

As used herein, the term “and/or” comprises any and all combinations of one or more of the associated listed items. In addition, the singular forms “a”, “an” and “the” are to be interpreted as “at least one”, thus also comprising a plurality, unless expressly stated otherwise. It will be further understood that the terms “includes”, “comprises”, “including” and/or “comprising”, specify the presence of stated features, actions, integers, steps, operations, elements, and/or components, but do not preclude the presence or addition of one or more other features, actions, integers, steps, operations, elements, components, and/or groups thereof.

What is claimed is:

1. A method in a receiver for accessing an access point of a wireless local area network, the receiver being configured both for radio communication with a cellular radio network node comprised in a cellular network and for accessing the wireless local area network via the access point, comprising:
acquiring a cell identifier (ID) from a memory of the receiver, wherein the cell ID has been received from the cellular radio network node;
matching the acquired cell ID with a cell ID stored in a table that comprises at least one stored cell ID and at least one reference to an access point associated therewith;
detecting the access point of the wireless local area network that is associated with the acquired cell ID in the table by searching for the access point; and
accessing the wireless local area network via the detected access point.

2. The method according to claim 1, wherein when no match is made between the acquired cell ID and any stored cell ID in the table and/or no detection of the access point is made, the method further comprises extending the time interval for searching any access point of the wireless local area network, wherein the time interval is extendable into infinity.

3. The method according to claim 1, wherein the table further comprises a value related to a received signal strength indication of a signal received from the cellular radio network node associated with the reference to the access point, wherein before matching the acquired cell ID, the method further comprises acquiring the received signal strength indication of a signal received from the cellular radio network node, and wherein matching the acquired cell ID further comprises matching the acquired received signal strength indication with the stored received signal strength indication in the table.

4. The method according to claim 1, wherein before matching the acquired cell ID, the method further comprises:
discovering that the receiver is connected to the wireless local area network via the access point; and
storing a reference to the discovered access point in the table associated with the acquired cell ID.

5. The method according to claim 4, further comprising receiving an instruction from a human user of the receiver to store the reference to the discovered access point in the table before storage.

6. The method according to claim 4, wherein the reference to the discovered access point is stored in the table associated with the acquired cell ID while the receiver is connected to the wireless local area network via the access point.

7. The method according to claim 5, wherein the reference to the discovered access point is stored in the table associated with the acquired cell ID while the receiver is connected to the wireless local area network via the access point.

8. The method according to claim 1, wherein the cellular network is based on any radio access technology of: Global System for Mobile Communications “GSM”, Enhanced Data Rates for GSM Evolution “EDGE”, Universal Mobile Telecommunications System “UMTS”, Code Division Access “CDMA”, “CDMA 2000”, Time Division Synchronous CDMA “TD-SCDMA”, Long Term Evolution “LTE”, and wherein the wireless local area network comprises Wireless Fidelity “Wi-Fi” as defined by any of Institute of Electrical and Electronics Engineers “IEEE” standards 802.11a, b, g and/or n.

9. A receiver for accessing an access point of a wireless local area network, the receiver being configured both for radio communication with a cellular radio network node comprised in a cellular network and for accessing the wireless local area network via the access point, comprising:
a receiving unit configured to receive a cell identifier (ID) from the cellular radio network node,
a processing circuit configured to:
acquire a cell ID from a memory of the receiver, wherein the cell ID has been received from the cellular radio network node;
match the acquired cell ID with a stored cell ID in a table comprising at least one stored cell ID and at least one reference to an access point associated therewith;
detect the access point of the wireless local area network that is associated with the acquired cell ID in the table by searching for the access point; and
access the wireless local area network via the access point; and
a memory configured to store the cell ID received from the cellular radio network node and also configured to store the at least one cell ID and the at least one reference to the access point associated therewith in the table.

10. The receiver according to claim 9, wherein the processing circuit is further configured to search for any access point of the wireless local area network at an extended time interval in case no match is made between the received cell ID and any stored cell ID in the table and/or no detection of the access point is made.

11. The receiver according to claim 9, wherein the table further comprises a value related to a received signal strength indication of a signal received from the cellular radio network node associated with the reference to the access point, and wherein the processing circuit is further configured to measure the received signal strength indication of a signal received from the cellular radio network node, and in addition is further configured to match the measured received signal strength indication with the stored received signal strength indication in the table.

12. The receiver according to claim 9, wherein the processing circuit is further configured to discover that the receiver is connected to the wireless local area network via the access point, and also configured to store a reference to the discovered access point in the table associated with the acquired cell ID in the memory.

13. The receiver according to claim 12, wherein the processing circuit is further configured to receive an instruction from a human user of the receiver to store the reference to the discovered access point in the table before storage in the memory.

14. The receiver according to claim 12, wherein the processing circuit is further configured to store the reference to the discovered access point in the table in the memory associated with the acquired cell ID while the receiver is connected to the wireless local area network via the access point.

15. The receiver according to claim 13, wherein the processing circuit is further configured to store the reference to the discovered access point in the table in the memory associated with the acquired cell ID while the receiver is connected to the wireless local area network via the access point.

16. The receiver according to claim 9, wherein the cellular network is based on any radio access technology of: Global System for Mobile Communications “GSM”, Enhanced Data Rates for GSM Evolution “EDGE”, Universal Mobile Telecommunications System “UMTS”, Code Division Access “CDMA”, “CDMA 2000”, Time Division Synchronous CDMA “TD-SCDMA”, Long Term Evolution “LTE”, and wherein the wireless local area network comprises Wireless Fidelity “Wi-Fi” as defined by any of Institute of Electrical and Electronics Engineers “IEEE” standards 802.11a, b, g and/or n.

17. A computer program in a receiver configured for accessing an access point of a wireless local area network, the receiver being configured both for radio communication with a cellular radio network node comprised in a cellular network and for accessing the access point of the wireless local area network, wherein the computer program has instructions for execution by a processor, wherein the instructions cause the processor to:
acquire a cell identifier (ID) from a memory of the receiver, wherein the cell ID has been received from the cellular radio network node;
match the acquired cell ID with a cell ID stored in a table that comprises at least one stored cell ID and at least one reference to an access point associated therewith;
detect the access point of the wireless local area network that is associated with the acquired cell ID in the table by searching for the access point; and
access the wireless local area network via the detected access point.
